(19) United States
(12) Patent Application Publication
(10) Pub. No.: US 2023/0074845 A1
(43) Pub. Date: Mar. 9, 2023

(54) FALSE EYELASHES AND METHOD FOR MANUFACTURING THE SAME

(71) Applicant: L'OREAL, Paris (FR)

(72) Inventor: Marine ROUALDES, Kawasaki-shi, Kanagawa (JP)

(73) Assignee: L'OREAL, Paris (FR)

(21) Appl. No.: 17/759,601

(22) PCT Filed: Jan. 8, 2021
(86) PCT No.: PCT/JP2021/001390

§ 371 Date: Jul. 27, 2022

(30) Foreign Application Priority Data
Jan. 29, 2020 (JP) 2020-012425
Mar. 5, 2020 (FR) 2002216

(51) Int. Cl. A41G 5/02; C09J 139/08; B29C 65/50

(52) U.S. Cl. CPC A41G 5/02; C09J 139/08; B29C 65/50; D10B 2401/041

(57) ABSTRACT

The present invention relates to false eyelashes (1), comprising: a plurality of discrete eyelash fibers (10); and a baseline (20) extending across the plurality of eyelash fibers (10) and linking the plurality of eyelash fibers (10) in parallel or substantially parallel with one another. The baseline (20) is formed of a solidified raw resin (20′). The solidified raw resin (20′) forming the baseline (20) at least partially covers the proximal ends of the plurality of eyelash fibers (10), thereby linking the plurality of eyelash fibers (10) with one another. The present invention also relates to a method for manufacturing such false eyelashes (1) by sandwiching the plurality of eyelash fibers (10) between lower and upper molds (100, 200) and filling a raw resin (20′) of the baseline (20) in a molten state into a narrow passage (300) defined between the lower and upper molds (100, 200).

### TECHNICAL FIELD

The present invention relates to false eyelashes, especially, tufted false eyelashes in which a plurality of discrete eyelash fibers are linked in parallel (or substantially parallel) with one another via a baseline extending across the plurality of eyelash fibers. The present invention also relates to a method for manufacturing such false eyelashes using lower and upper molds.

### BACKGROUND ART

Currently, many women use false eyelashes on a daily or occasional basis for cosmetic purposes. The most commonly used ones are tufted false eyelashes having a structure in which a plurality of eyelash fibers are linked in parallel with one another via single fiber, i.e., a baseline intersecting with them.

In general, because of their delicate structure, false eyelashes, especially tufted false eyelashes, are manufactured by hand one by one by humans. Because of such a labor intensive production method, the productivity is low and the manufacturing cost is quite high. In order to solve this problem, automated production of false eyelashes has been attempted in recent years. However, it is difficult to balance the good appearance of the obtained product with high productivity and low production cost.

Furthermore, conventional false eyelashes require improvements in the following points. The length of the false eyelashes (i.e., the length along the baseline) available on the market often does not match the length of the user's eyelid edge. For this reason, it is necessary for the user to adjust the length of the false eyelashes, that is, to remove the extra portion in accordance with the length of her eyelid edge before wearing the false eyelashes. It is preferable that a user be able to perform such a task easily and quickly using only her hands. However, as described above, conventional false eyelashes have a structure in which a plurality of eyelash fibers are linked with one another by a baseline made of a fiber, and thus it is difficult for the user to tear the baseline with her hands. Therefore, tools such as scissors are required to adjust the length of the false eyelashes.

In view of the above, there is a need for false eyelashes with a good appearance which can be produced, in particular, automatically produced at lower cost and more efficiently than the prior art false eyelashes. Furthermore, there is a need for false eyelashes that allow the user to adjust the length of the false eyelashes using only her hands without using tools such as scissors. In addition to this, there is a need for a method for manufacturing such false eyelashes with high productivity and low production cost.

FR3038499, U.S. Pat. No. 2,667,176, WO2013171232, and US20140263392, for example, disclose prior art considered to be related to the present invention, i.e., false eyelashes or manufacturing method thereof. FR3038499 generally discloses a device for dispensing artificial eyelashes. U.S. Pat. No. 2,667,176 generally discloses a dispensing applicator for false eyelashes and the like. WO2013171232 generally discloses an implement for applying false eyelashes to a human eyelid. Furthermore, US20140263392 generally discloses a method for applying false eyelashes with an applicator for dispensing false eyelashes. However, these prior art techniques do not solve the problems described above.

### DISCLOSURE OF THE INVENTION

One object of the present invention is to solve the current problems arising from reliance on manual production, more specifically, to provide false eyelashes with a good appearance which can be produced, in particular, automatically produced at lower cost and more efficiently than the prior art false eyelashes. Another object of the present invention is to provide false eyelashes that allow the user to adjust the length of the false eyelashes using only her hands without using tools such as scissors. A further object of the present invention is to provide a method for manufacturing false eyelashes which can simultaneously achieve the good appearance of the obtained product as well as high productivity and low production cost.

In order to achieve the above-stated objects, the present invention provides false eyelashes, comprising: a plurality of discrete eyelash fibers; and a baseline extending across the plurality of eyelash fibers and linking the plurality of eyelash fibers in parallel or substantially parallel with one another, wherein the baseline is formed of a solidified raw resin, and wherein the solidified raw resin forming the baseline at least partially covers the proximal ends of the plurality of eyelash fibers, thereby linking the plurality of eyelash fibers with one another.

The present invention also provides a method for manufacturing false eyelashes in which a plurality of discrete eyelash fibers are linked in parallel or substantially parallel with one another via a baseline extending across the plurality of eyelash fibers, by using a lower mold and an upper mold, the method comprising the steps of: supplying the plurality of eyelash fibers onto an upper surface of the lower mold side by side with respect to one another, wherein the upper surface of the lower mold includes a first groove extending so as to intersect the eyelash fibers to be supplied; combining the lower mold and the upper mold in a state where the plurality of eyelash fibers are sandwiched between the lower mold and the upper mold, wherein a bottom surface of the upper mold includes a second groove, which is arranged so as to be opposed to the first groove of the lower mold when the lower mold and the upper mold are combined with each other; after the lower mold and the upper mold are combined with each other, filling a raw resin for the baseline in a molten state into a passage defined by the first groove of the lower mold and the second groove of the upper mold facing each other; and after the raw resin filled into the passage is solidified, separating the lower mold and the upper mold from each other, and removing a precursor of the false eyelashes in which the plurality of eyelash fibers are linked in parallel or substantially parallel with one another via the baseline consisting of the solidified raw resin.

According to the present invention, a baseline that had conventionally been composed of a fiber is replaced by a baseline that is made of a solidified raw resin. This eliminates the troublesome work of connecting individual eyelash fibers and the baseline individually. As a result of this, it is possible to industrially produce tufted false eyelashes, which are conventionally manufactured one by one manually because of their delicate structure, without relying on human hands. This means that the production of tufted false eyelashes can be completely automated. Therefore, according to the present invention, high productivity and low production costs can be realized in the production of tufted false eyelashes. Furthermore, according to the present invention, it is also possible to realize tufted false eyelashes having an equivalent appearance to those obtained by conventional manufacturing methods with high productivity and low production cost. In addition to this, according to the present invention, since the baseline of the false eyelashes is made of a solidified raw resin, it is possible for the user to tear the baseline using only her hands. Therefore, the user can easily and quickly adjust the length of the false eyelashes, that is, remove the extra portion with her hands without using tools such as scissors before wearing the false eyelashes.

According to one preferred aspect of the present invention, the baseline may be an overmolded arrangement consisting of the solidified raw resin. That is, the baseline may be formed using an overmold process. In this preferred aspect, the eyelash fibers are linked with one another by the overmolded baseline with a necessary thickness.

According to one preferred aspect of the present invention, the regions of the proximal ends (i.e., the ends closer to the user's eyelid) of the plurality of eyelash fibers which protrude from the back side of the baseline may be trimmed by a heat treatment. In other words, in one preferred aspect of the present invention, the proximal ends of the plurality of eyelash fibers may be trimmed and blunted by the heat treatment. According to one preferred aspect of the present invention, the regions of the proximal ends of the plurality of eyelash fibers which protrude from the back side of the baseline are linked with one another at least partially along the extending direction of the baseline by a heat treatment. These preferred aspects of the present invention can prevent irritation to the eyelids of the user (which can be painful for the eyelids) by the proximal tip of the eyelash fiber. Furthermore, according to these preferred aspects, the contact area between the adhesive normally applied to the user's natural eyelashes and the false eyelashes increases in the region of the proximal end of the eyelash fiber of the false eyelashes. Therefore, a stable attachment state of the false eyelashes to the user's natural eyelashes can be maintained over a long time.

According to one preferred aspect of the present invention, the regions of the proximal ends of the plurality of eyelash fibers which protrude from the back side and/or the front side of the baseline may be at least partially flattened with respect to the cross section thereof. As used herein, the term “back side” of the baseline means the side of the baseline which faces the eyelid of the user. Contrary to this, the term “front side” of the baseline means the side of the baseline which faces away from the eyelid of the user.

According to one preferred aspect of the present invention, the baseline may be made from a thermoplastic material, such as a hydrogenated styrenic thermoplastic elastomer (SEBS). According to one preferred aspect of the present invention, the baseline may be made from a silicon material. Furthermore, according to one preferred aspect of the present invention, the plurality of eyelash fibers may be made from a non-thermoplastic material, such as a polyamide (PA) or polybutylene-terephthalate (PBT). According to one preferred aspect of the present invention, the plurality of eyelash fibers may be made from rayon, viscose, acetate, acrylic polymer, polyolefin, polyethylene terephthalate (PET), polyester, human hair or fibers formed from a mixture of polymers such as those mentioned above, for instance polyamide/polyester fibers.

According to one preferred aspect of the manufacturing method of the present invention, the method may further comprise: the step of eliminating the excess portions of the baseline protruding outwardly from the eyelash fibers located at both ends of the precursor of the false eyelashes.

According to one preferred aspect of the manufacturing method of the present invention, the method may further comprise: the step of trimming the regions of the proximal ends of the plurality of eyelash fibers which protrude from the back side of the baseline by a heat treatment. In this preferred aspect, the proximal ends of the plurality of eyelash fibers are also blunted by the heat treatment. Furthermore, in one preferred aspect, the regions of the proximal ends of the plurality of eyelash fibers which protrude from the back side of the baseline may be linked with one another at least partially, preferably entirely or almost entirely, along the extending direction of the baseline by the trimming step.

According to one preferred aspect of the manufacturing method of the present invention, the method may further comprise: the step of simultaneously carrying out curling of each eyelash fiber of the false eyelashes precursor by a heat treatment and shaping of the baseline of the precursor into an arcuate shape by a heat treatment, or the step of sequentially carrying out the curling and the shaping.

According to one preferred aspect of the manufacturing method of the present invention, the first groove of the lower mold and the second groove of the upper mold may extend orthogonally or substantially orthogonally to at least some of the eyelash fibers to be supplied onto the upper surface of the lower mold. In one preferred aspect, at least some of the eyelash fibers may form an angle of, for example, 70 to 110 degrees with respect to the baseline. In particular, it is preferable that the first groove of the lower mold and the second groove of the upper mold extend in a straight line. The cross-sectional shapes of the first and second grooves may be the same or different. When the cross-sectional shape of the first and second grooves is, for example, semicircular, the radius thereof may be, but is not limited to, about half to several times the diameter of the eyelash fiber.

### BRIEF DESCRIPTION OF THE DRAWINGS

Non-limiting and representative embodiments of the present invention will now be explained in detail below referring to the attached drawings.

FIG. 1 is a schematic perspective view of tufted false eyelashes according to one embodiment of the present invention.

FIG. 2 is an enlarged plan view of the encircled area A shown in FIG. 1.

FIG. 3 is a cross-sectional view taken along line X-X shown in FIG. 2.

FIG. 4 is a view similar to FIG. 2, showing a part of tufted false eyelashes according to another embodiment of the present invention

FIG. 5 is a schematic view of a system for manufacturing tufted false eyelashes.

FIG. 6 is a cross-sectional view related to the processes for obtaining a false eyelashes precursor using lower and upper molds.

FIG. 7 is a perspective view showing a false eyelashes precursor obtained through the processes shown in FIG. 6.

FIG. 8 is a schematic view showing further processes for obtaining false eyelashes from the precursor shown in FIG. 7.

FIG. 9 is a plan view of the lower mold in an alternative embodiment of the present invention showing that an annular groove extending to intersect a plurality of eyelash fibers is formed on the upper surface of the lower mold.

FIG. 10 is a schematic view showing how a false eyelashes precursor formed using a molding unit including the lower mold shown in FIG. 9 is cut.

### DETAILED DESCRIPTION OF EMBODIMENTS

Some exemplary embodiments of the present invention will now be described with reference to FIGS. 1 to 10. Throughout these figures, the scale ratios of width, length, height, and diameter of some elements or portions thereof as well as distance therebetween are not constant and may differ from actual ratios. It should be noted that in certain figures, certain elements or portions thereof are drawn larger than they actually are for emphasis.

FIG. 1 schematically shows tufted false eyelashes 1, which are one exemplary embodiment of the present invention. As shown in FIG. 1, the tufted false eyelashes 1 (hereinafter, simply called “false eyelashes”) comprise a plurality of discrete eyelash fibers 10 and a baseline 20 with a necessary rigidity and flexibility. The baseline 20 extends across the plurality of eyelash fibers 10 and links these eyelash fibers 10 substantially parallel with one another. The eyelash fibers 10 are curved along their extending direction. Similarly, the baseline 20 is curved along its extending direction. Furthermore, the eyelash fibers 10 are arranged such that the distance between the distal ends (free ends) thereof is slightly larger than the distance between the proximal ends (fixed ends) thereof.

In this embodiment, the plurality of eyelash fibers 10 are made from a non-thermoplastic material, for example, a polyamide (PA) or polybutylene-terephthalate (PBT). On the other hand, the baseline 20 is formed of a solidified raw resin. More specifically, the baseline 20 is formed using a thermoplastic elastomer (TPE), for example, a hydrogenated styrenic thermoplastic elastomer (SEBS). In other words, the baseline 20 is an overmolded arrangement consisting of the solidified raw resin as such. In these false eyelashes 1 presented as an exemplary embodiment of the present invention, as explained in detail later, the solidified raw resin forming the baseline 20 partially covers the proximal ends of the plurality of eyelash fibers 10, thereby linking the plurality of eyelash fibers 10 with one another.

Although not limited to this, in one embodiment of the present invention, the number of eyelash fibers 10 may be ten to several tens, and the diameter of each eyelash fiber 10 may be about 0.1 to 0.8 mm. The diameter or width of the baseline 20 may be about 0.1 to 2 mm. The color of the eyelash fibers 10 may be black or brown, and the color of the baseline 20 may be white, skin color, or colorless and transparent.

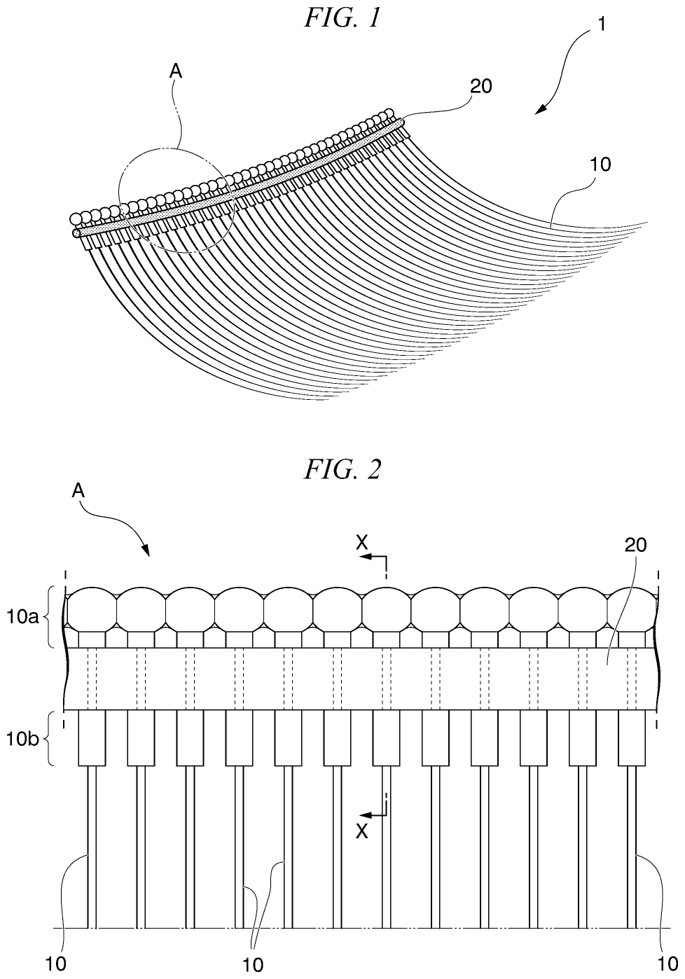

As shown in detail in FIG. 2, which is an enlarged plan view of the encircled area A shown in FIG. 1, regions 10a of the proximal ends of the plurality of eyelash fibers 10 which protrude from the back side (facing the eyelid when worn) of the baseline 20 are trimmed by a heat treatment. As a result of this heat treatment, the regions 10a of the proximal ends of the plurality of eyelash fibers 10 which protrude from the baseline 20 partially melt and are entirely or almost entirely linked with one another along the extending direction of the baseline 20. As can be understood by those skilled in the art, the breaking strength of the bond between the regions 10a is lower than the breaking strength of the eyelash fiber 10 itself. As also can be seen from FIG. 2, the region 10a of the proximal end of each eyelash fiber 10 naturally exhibits a spherical appearance. In another embodiment, the linkage between the regions 10a of the proximal ends of the plurality of eyelash fibers 10 may be partially present or may not be present.

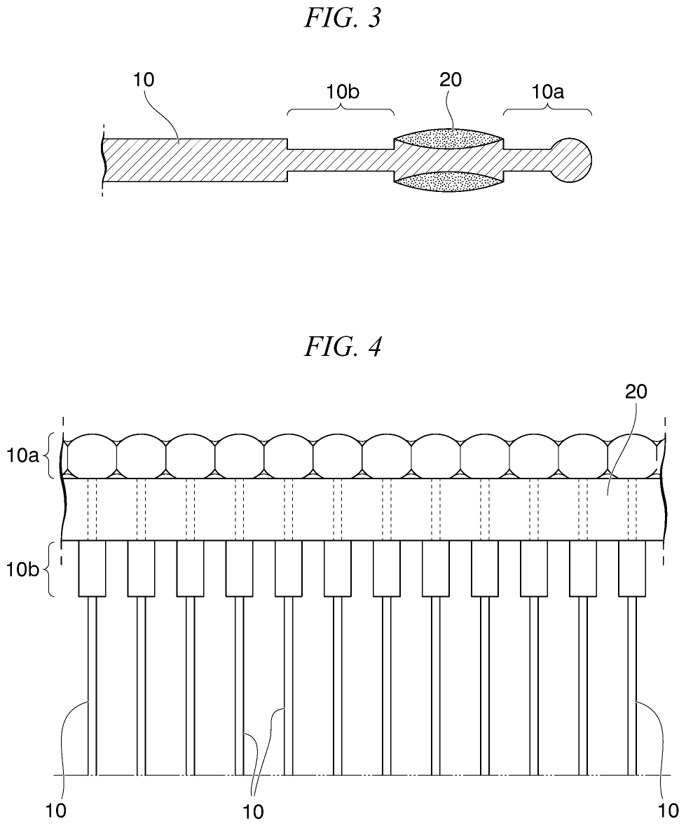

As shown in FIG. 3, which is a cross-sectional view taken along line X-X shown in FIG. 2, the regions 10a of the proximal ends of the plurality of eyelash fibers 10 which protrude from the back side of the baseline 20 is partially flattened (or widened) with respect to the cross section thereof. Similarly, the regions 10b of the proximal ends of the plurality of eyelash fibers 10 which protrude from the front side of the baseline 20 are also flattened with respect to the cross section thereof. In this embodiment, the flattened portions of the eyelash fibers 10 are present on both sides of the baseline 20. However, in another embodiment as shown in FIG. 4, the flattened portions of each of the eyelash fibers 10 are present only on one side of the baseline 20, in particular, on the free end side of each eyelash fiber 10.

Also, as can be seen from FIG. 3, the upper and lower surfaces of a section of each eyelash fiber 10 that contacts with the baseline 20 (this section is not flattened) are slightly depressed. This is because the molten resin, which will eventually form the baseline 20, filled into assembled molds (described below) of the manufacturing system shrinks slightly when solidifying and consequently squeezes the eyelash fibers 10. This improves the physical bond strength between each eyelash fiber 10 and the baseline 20.

In the exemplary embodiments described above, since the baseline 20 that has conventionally been composed of a fiber is replaced by the baseline 20 that is made of a solidified raw resin, the troublesome work such as connecting individual eyelash fibers and the baseline can be avoided during production. As a result, it is possible to industrially produce tufted false eyelashes, which are conventionally manufactured one by one manually because of their delicate structure, without relying on human hands. That is, the production of tufted false eyelashes can be completely automated, and high productivity and low production costs can be realized in the production of tufted false eyelashes. Furthermore, according to the exemplary embodiments described above, it is also possible to realize tufted false eyelashes having an equivalent appearance to those obtained by conventional manufacturing methods with high productivity and low production costs. In addition to this, according to the exemplary embodiments described above, it is further possible for the user to tear the baseline 20 using only her hands. Therefore, the user can easily and quickly adjust the length of the false eyelashes, that is, remove the extra portion using only her hands without using tools such as scissors before wearing the false eyelashes.

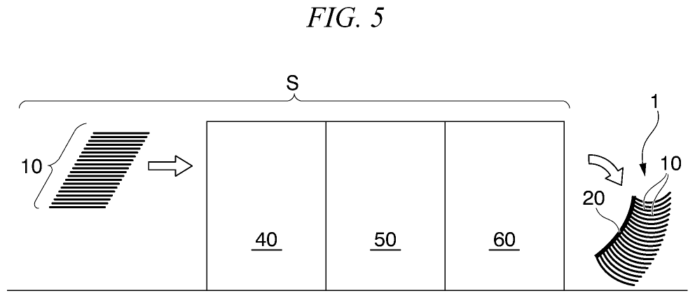

Hereinafter, a method and a system for manufacturing the false eyelashes shown in FIGS. 1 to 4 will be described in detail with reference to FIGS. 5 to 8.

FIG. 5 schematically shows a system S for manufacturing the above described tufted false eyelashes 1. The system S is intended to produce the tufted false eyelashes 1 using the lower and upper molds as described below. The system S comprises a source (not shown) of the plurality of eyelash fibers 10. The eyelash fibers 10 are supplied in a state of being precut to a predetermined length, for example, several millimeters to 2 cm. Especially, the necessary number of eyelash fibers 10 may be supplied as a group. The lengths of each of the eyelash fibers 10 may be the same or may be different.

The system S further comprises a molding unit 40 to which the eyelash fibers 10 are supplied, a cutting and trimming unit 50, and a thermoforming unit 60. These units 40, 50, and 60 are functionally connected in a row. In another embodiment of the present invention, the order of the cutting and trimming unit 50 and the thermoforming unit 60 may be reversed.

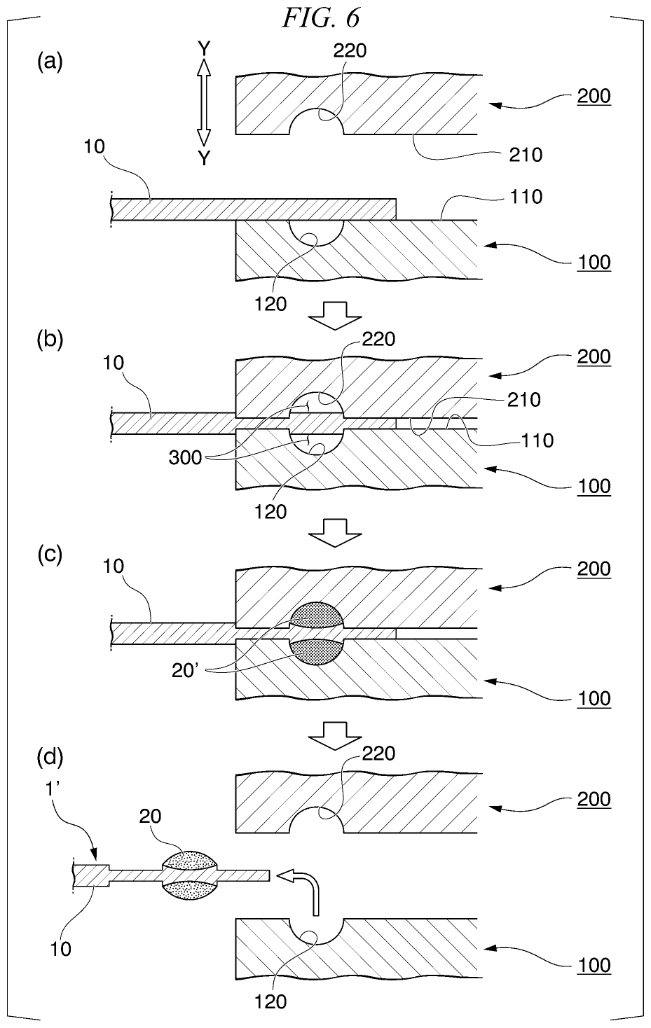

As described above and as can be seen from FIG. 6 (a), the molding unit 40 has a pair of a lower mold 100 and an upper mold 200, and a filling device (not shown) for filling a raw resin for baseline 20 into combined molds 100, 200. Onto an upper surface 110 of the lower mold 100, a plurality of eyelash fibers 10 are supplied substantially parallel with one another from the source thereof. FIG. 6 (a) shows the state in which a plurality of eyelash fibers 10 are placed on the upper surface 110 of the lower mold 100. In this embodiment, an area of the upper surface 110 of the lower mold 100 onto which the plurality of eyelash fibers 10 are placed is arranged at a periphery of the upper surface 110. Therefore, a substantial part of each eyelash fiber 10 placed on the upper surface 110 of the lower mold 100 protrudes outward from the upper surface 110.

Also as can be seen from FIG. 6 (a), the upper surface 110 of the lower mold 100 includes a first groove 120 extending so as to intersect with the eyelash fibers 10 to be supplied, in particular orthogonally (or substantially orthogonally) thereto. The first groove 120 is present in the area which is parallel with one side of the lower mold 100. In this embodiment, the groove 120 has a straight shape, but in another embodiment, the groove 120 may have an arcuate shape. Furthermore, although the cross section of the groove 120 is semicircular in this embodiment, other types of cross sections may be adopted as appropriate. For the case when the cross section of the groove 120 is semicircular, the diameter thereof may be 0.1 to 1 mm, although is not limited thereto.

The upper mold 200 paired with the lower mold 100 is arranged to be capable of combining with the lower mold 100 in a state where the plurality of eyelash fibers 10 are sandwiched between the lower mold 100 and the upper mold 200, and to be capable of separating from the lower mold 100. That is, the upper mold 200 is vertically displaceable along the line Y-Y in FIG. 6 (a) using an actuator that is not shown.

Similar to the lower mold 100, a bottom surface 210 of the upper mold 200 includes a second groove 220. This groove 220 is arranged so as to be opposed to the first groove 120 of the lower mold 100 when the lower mold 100 and the upper mold 200 are combined with one another. The second groove 220 of the upper mold 200 also extends orthogonally to the eyelash fibers 10 to be supplied onto the upper surface 110 of the lower mold 100. In this embodiment, the dimensions and cross-sectional shape of the groove 220 are identical to those of the groove 120 of the lower mold 100.

The filling device (not shown) forming the molding unit 40 together with the pair of the lower mold 100 and the upper mold 200 is configured to fill a raw resin for the baseline 20 in a molten state into a passage 300 (see FIG. 6 (b)) of the combined molds 100, 200. The passage 300 is defined by the first groove 120 of the lower mold 100 and the second groove 220 of the upper mold 200 facing each other. The passage 300 extends orthogonally to the eyelash fibers 10 to be sandwiched between the lower mold 100 and the upper mold 200. Because the groove 120 of the lower mold 100 and the groove 220 of the upper mold 200 are both linear in shape, the passage 300 defined therefrom is also linear.

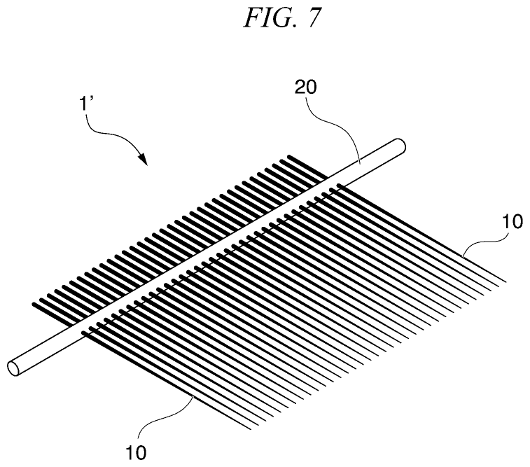

As is apparent from the above descriptions and as can be seen from FIG. 6 (c), the baseline 20 of the false eyelashes 1 is formed from a raw resin 20′ filled into the passage 300 defined by the first groove 120 of the lower mold 100 and the second groove 220 of the upper mold 200. A precursor 1′ of the false eyelashes 1 thus obtained is shown in FIG. 7.

Referring again to FIG. 5, in the system S, the cutting and trimming unit 50 is installed at a position following the molding unit 40. The cutting and trimming unit 50 is configured to eliminate the excess portions of the baseline 20, which protrude outward from the eyelash fibers 10 located at both ends of the precursor 1′ of the false eyelashes 1, using a cutter that is not shown. Furthermore, the cutting and trimming unit 50 is configured to trim the proximal ends of the eyelash fibers 10 protruding from the back side of the baseline 20, using a heat cutter that is not shown. That is, the cutting and trimming unit 50 is configured so that the heat treatment is applied to the proximal end of the eyelash fiber 10 in order to blunt it as described with reference to FIGS. 2 and 4.

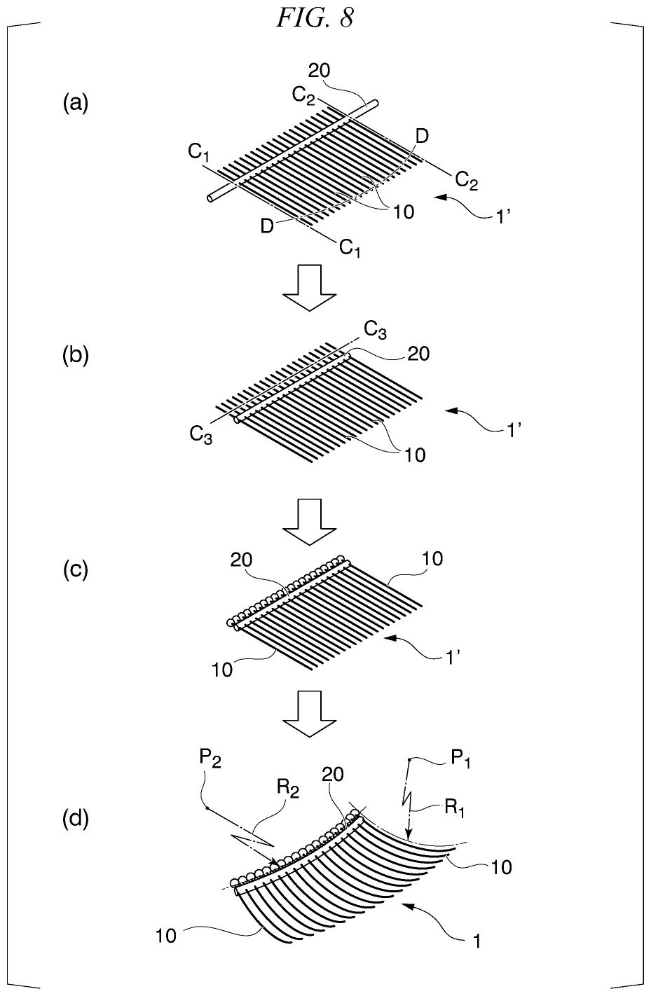

The thermoforming unit 60 installed in a position after the separating unit 50 is configured to curl each eyelash fiber 10 of the precursor 1′ of the false eyelashes 1 by thermoforming (heat treatment) using a suitable mold that is not shown. The thermoforming unit 60 is further configured to subsequently form the baseline 20 of the precursor 1′ of the false eyelashes 1 into an arcuate shape by thermoforming (heat treatment) also using another suitable mold that is not shown. The precursor 1′ prior to a treatment by the thermoforming unit 60 is shown in FIG. 8 (c), and the precursor 1′ after treatment by the thermoforming unit 60, i.e., the finished tufted false eyelashes 1, is shown in FIG. 8 (d). In one embodiment, as shown in FIG. 8 (d), each eyelash fiber 10 of tufted false eyelashes 1 has a substantially constant (or changing) radius of curvature R₁ centered on the imaginary point P₁, and the baseline 20 has a substantially constant (or changing) radius of curvature R₂ centered on the imaginary point P₂.

In another embodiment, the installation order of the cutting and trimming unit 50 and the thermoforming unit 60 may be reversed.

Subsequently, the method for manufacturing tufted false eyelashes according to one embodiment of the present invention using the above system S will be described in detail with reference to FIGS. 6 to 8. However, it should be noted that the method of manufacturing false eyelashes according to the present invention can be implemented without using the above system.

In this method, first, a plurality of eyelash fibers 10 are supplied onto the upper surface 110 of the lower mold 100 in a state in which they are arranged side by side with respect to one another. The supplied eyelash fibers 10 are arranged to intersect the first groove 120 of the upper surface 110 of the lower mold 100 (see FIG. 6 (a)).

Subsequently, the upper mold 200 is combined with the lower mold 100 in a state where the plurality of eyelash fibers 10 are sandwiched between the lower mold 100 and the upper mold 200 (see FIG. 6 (b)).

After the upper mold 200 and the lower mold 100 are completely combined, the raw resin 20′ for the baseline 20 (for example, a thermoplastic elastomer (TPE), in particular, a hydrogenated styrenic thermoplastic elastomer (SEBS)) in the molten state is filled into the passage 300 defined by the groove 120 of the lower mold 100 and the groove 220 of the upper mold 200 facing each other (see FIG. 6 (c)).

After the raw resin 20′ filled into the passage 300 has been fully or completely solidified, the lower mold 100 and the upper mold 200 are separated from each other, and the precursor 1′ of the false eyelashes is removed from the molds (see FIG. 6 (d)). At this stage, as stated above, the plurality of eyelash fibers 10 are linked with one another by the baseline 20 composed of the solidified raw resin 20′ (see FIG. 7). In particular, the raw resin 20′ is in a state of being overmolded on each eyelash fiber 10.

Thereafter, the excess portions of the baseline 20 projecting outwardly from the eyelash fibers 10 located at both ends of the precursor 1′ are separated (eliminated) from the rest of the baseline 20 along the lines indicated by C₁-C₁ and C₂-C₂ in FIG. 8 (a). Furthermore, following (or simultaneously) with this step, the region 10a of the proximal ends of the eyelash fibers 10 protruding from the back side of the baseline 20 are trimmed along the line indicated by C₃-C₃ in FIG. 8 (b) by the heat treatment. The false eyelashes precursor 1′ on which these steps have been completed is shown in FIG. 8 (c).

Finally, each eyelash fiber 10 of the precursor 1′ is curled by thermoforming, and furthermore, the baseline 20 of the precursor 1′ is shaped into an arcuate shape by thermoforming (see FIG. 8 (d)). The thermoforming of each eyelash fiber 10 of the precursor 1′ and the thermoforming of the baseline 20 of the precursor 1′ may be performed simultaneously or in the reverse order of the above description. Furthermore, in another embodiment of the present invention, the cutting and trimming step and the thermoforming step may be performed in reverse order. In addition to the above, the eyelash fibers may be further processed. More specifically, the free tip of each eyelash fiber 10 can be cut along any straight line, curve, or zigzag line so that the eyelash fibers 10 have different lengths with respect to each other. In one example, the free end of each eyelash fiber may be further cut along the curve indicated by D-D in FIG. 8 (a). In addition, the eyelash fibers may be previously processed to be tapered so that the diameter of the eyelash fibers decreases toward the free tip thereof

As mentioned above, according to the exemplary embodiments of the present invention, it is possible to industrially, that is, automatically produce tufted false eyelashes, which are conventionally manufactured one by one manually because of their delicate structure, without relying on human hands. As a result, according to the exemplary embodiments, high productivity and low production costs can be realized in the production of tufted false eyelashes with a good appearance.

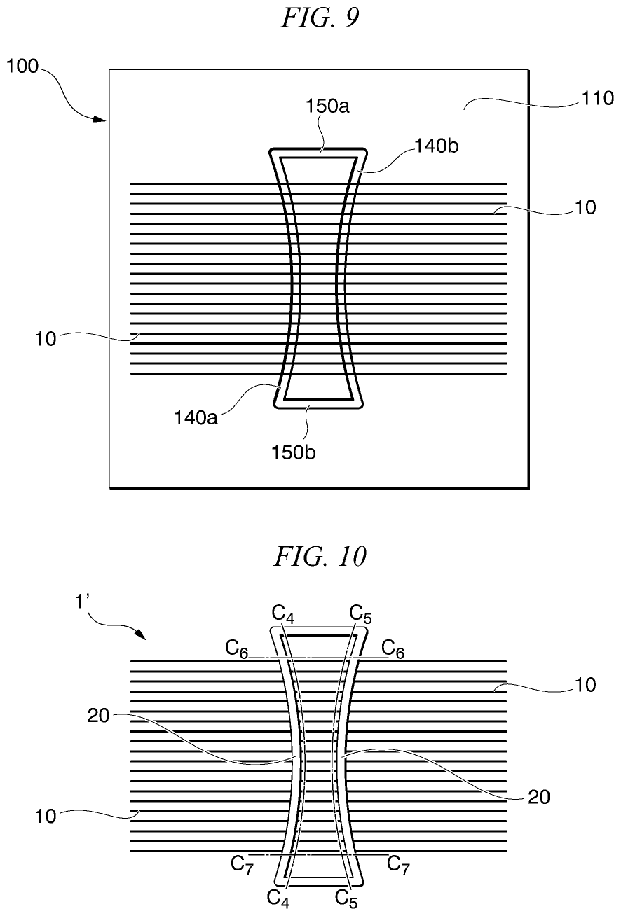

FIG. 9 is a top view of the lower mold 100 of the molding unit 40 according to an alternative embodiment. In this alternative embodiment, the upper surface 110 of the lower mold 100 includes two elongated grooves 140a, 140b extending to intersect with a plurality of eyelash fibers 10 adjacent to each other. The two elongated grooves 140a, 140b are connected to each other by two short grooves 150a, 150b arranged parallel to the eyelash fibers 10. As a result, a looped groove is formed on the upper surface 110 of the lower mold 100. Although not shown, on the bottom surface of the upper mold (not shown) paired with the lower mold 100, two corresponding elongated grooves and two corresponding short grooves are formed. As a result, a similar looped groove is also formed in the upper mold paired with the lower mold 100. Therefore, when the lower mold 100 and the upper mold that is not shown are combined, a looped passage for filling the molten resin is formed between the two molds. Although FIG. 9 shows a pair of arcuate grooves 140a, 140b curved in a concave lens-like shape, the shape of these grooves may be linear or curved in a convex lens-like shape.

FIG. 10 shows a false eyelashes precursor 1′, i.e., a linked precursor, formed using the molding unit including the lower mold 100 shown in FIG. 9. This precursor 1′ has a structure in which the eyelash fibers 10 are linked with one another at two points by two baselines 20. The two baselines 20 themselves are also connected via extensions at both ends. This precursor 1′ is cut through lines C₄-C₄, C₅-05, C₆-C₆, and C₇-C₇ shown in FIG. 10. Subsequently, their baselines 20 are counter-curved and the eyelash fibers 10 are curled by thermoforming to obtain two tufted false eyelashes, one of which is the same as the one shown in FIG. 8 (d). According to this alternative embodiment, one molding process results in two false eyelashes, which increases production efficiency. The number of elongated grooves extending to intersect the eyelash fibers is not limited to two, and in a further alternative embodiment, the molds may have three or more elongated grooves disposed adjacent to each other.

The preferred embodiments of the present invention have been explained above in detail referring to the drawings. However, the present invention is not limited to these embodiments, and various modifications and changes may be made to the above-described embodiments without deviating from the scope of the present invention, and such modifications and changes are also included in the scope of the present invention.

1. False eyelashes, comprising:
a plurality of discrete eyelash fibers; and
a baseline extending across the plurality of eyelash fibers and linking the plurality of eyelash fibers in parallel or substantially parallel with one another,
wherein the baseline is formed of a solidified raw resin, and
wherein the solidified raw resin forming the baseline at least partially covers the proximal ends of the plurality of eyelash fibers, thereby linking the plurality of eyelash fibers with one another.

2. False eyelashes according to claim 1, wherein the baseline is an overmolded arrangement consisting of the solidified raw resin.

3. False eyelashes according to claim 1, wherein regions of the proximal ends of the plurality of eyelash fibers which protrude from the back side of the baseline are trimmed by a heat treatment.

4. False eyelashes according to claim 1, wherein regions of the proximal ends of the plurality of eyelash fibers which protrude from the back side of the baseline are linked with one another at least partially along the extending direction of the baseline by a heat treatment.

5. False eyelashes according to claim 1, wherein regions of the proximal ends of the plurality of eyelash fibers which protrude from the back side and/or the front side of the baseline is at least partially flattened with respect to the cross section thereof.

6. False eyelashes according to claim 1, wherein the baseline is made from a thermoplastic material, such as a hydrogenated styrenic thermoplastic elastomer (SEBS).

7. False eyelashes according to claim 1, wherein the plurality of eyelash fibers is made from a non-thermoplastic material, such as a polyamide (PA) or a polybutylene-terephthalate (PBT).

8. A method for manufacturing false eyelashes in which a plurality of discrete eyelash fibers are linked in parallel or substantially parallel with one another via a baseline extending across the plurality of eyelash fibers, by using a lower mold and an upper mold, the method comprising the steps of:
supplying the plurality of eyelash fibers onto an upper surface of the lower mold side by side with respect to one another, wherein the upper surface of the lower mold includes a first groove extending so as to intersect with the eyelash fibers to be supplied;
combining the lower mold and the upper mold in a state where the plurality of eyelash fibers are sandwiched between the lower mold and the upper mold, wherein a bottom surface of the upper mold includes a second groove, which is arranged so as to be opposed to the first groove of the lower mold when the lower mold and the upper mold are combined with each other;
after the lower mold and the upper mold are combined with each other, filling a raw resin for the baseline in a molten state into a passage defined by the first groove of the lower mold and the second groove of the upper mold facing each other; and
after the raw resin filled into the passage is solidified, separating the lower mold and the upper mold from each other, and removing a precursor of the false eyelashes in which the plurality of eyelash fibers are linked in parallel or substantially parallel with one another via the baseline consisting of the solidified raw resin.

9. The method according to claim 8, further comprising: the step of eliminating the excess portions of the baseline protruding outwardly from the eyelash fibers located at both ends of the precursor.

10. The method according to claim 8, further comprising: the step of trimming regions of the proximal ends of the plurality of eyelash fibers which protrude from the back side of the baseline by a heat treatment.

11. The method according to claim 10, wherein the regions of the proximal ends of the plurality of eyelash fibers which protrude from the back side of the baseline are linked with one another at least partially along the extending direction of the baseline by the trimming step.

12. The method according to claim 8, further comprising: the step of simultaneously carrying out curling of each eyelash fiber of the precursor by a heat treatment and shaping of the baseline of the precursors into an arcuate shape by a heat treatment, or the step of sequentially carrying out the curling and the shaping.
